(19) United States
(12) Patent Application Publication
(10) Pub. No.: US 2015/0177455 A1
(43) Pub. Date: Jun. 25, 2015

(54) LIGHTING DEVICE

(71) Applicant: Justin CHOU, Taipei City (TW)

(72) Inventor: Justin CHOU, Taipei City (TW)

(21) Appl. No.: 14/255,353

(22) Filed: Apr. 17, 2014

(30) Foreign Application Priority Data
Dec. 24, 2013 (TW) 102148042

(51) Int. Cl. F21V 8/00; F21L 4/08

(52) U.S. Cl. CPC G02B 6/0096; F21L 4/08; F21W 2111/10

(57) ABSTRACT

A lighting device is formed of a bistable spring, a housing, a flexible light guide member, and a lighting module. The bistable spring is changeable between an uncurled state and a curled state and includes a springy main body and a covering layer. The covering layer covers the springy main body. The housing is fixed to the bistable spring. The flexible light guide member is connected with the bistable spring and includes two terminal portions. The two terminal portions of the flexible light guide member are inserted into the housing. The lighting module is mounted inside the housing for emitting light toward the two terminal portions. In this way, the lighting device is easy for assembly and energy-saving.

### BACKGROUND OF THE INVENTION

1. Field of the Invention

The present invention relates generally to a lighting device and more particularly, to a lighting device having a bistable spring.

2. Description of the Related Art

A bistable spring has been the common prior art in the industry. For example, U.S. Pat. Nos. 6,220,916 and 8,506,158 disclosed different applications based on the bistable spring. U.S. Pat. Nos. 6,220,916 disclosed a toy band with pre-recorded message, in which a housing and a bistable spring are assembled together or the housing and the bistable spring are separated from each other and the housing includes a dome which can flash as a message is broadcasted.

As the lives of the modern people become more and more hectic, they usually take advantage of off-duty hours to do exercise, such as jogging outdoors in the nighttime. However, it is dark and dim in the nighttime and if they do not have any proper marking, it will be risky for them to collide with other people or vehicles, so it is very important to have proper markings on their bodies. However, the aforesaid two patents did not disclose any bistable spring applied to the lighting device.

### SUMMARY OF THE INVENTION

The primary objective of the present invention is to provide a lighting device capable of emitting multi-directional light.

The secondary objective of the present invention is to provide a lighting device having fewer luminants and being energy-saving.

The foregoing objectives of the present invention are attained by the lighting device formed of a bistable spring, a housing, a first flexible light guide member, and a lighting module. The bistable spring is changeable between an uncurled state and a curled state and includes a springy main body and a covering layer. The covering layer covers the springy main body. The housing is fixed to the bistable spring. The first flexible light guide member is connected with the bistable spring and includes two terminal portions. The two terminal portions of the first flexible light guide member are inserted into the housing. The lighting module is mounted inside the housing for emitting light toward the two terminal portions.

The first flexible light guide member is flexible to adapt to the variation of the bistable spring whatever the bistable spring is of the uncurled state or the curled state. In addition, the light can be reflected inside the first flexible light guide member and the first flexible light guide member can reveal the visible light as a whole. In light of this, the bistable spring does not need to be connected with or have any luminant, so the lighting device of the present invention can be easily assembled, need fewer luminants, and be energy-saving.

### BRIEF DESCRIPTION OF THE DRAWINGS

FIG. 1 is a front perspective view of a first preferred embodiment of the present invention.

FIG. 2 is a rear perspective view of the first preferred embodiment of the present invention.

FIG. 3 is a sectional view taken along a line 3-3 indicated in FIG. 1.

FIG. 4 is a partially exploded view of the first preferred embodiment of the present invention.

FIG. 5 is a partially sectional view of the first preferred embodiment of the present invention, illustrating that the lighting device is curled.

FIG. 6 is an enlarged view of a part of the first preferred embodiment of the present invention.

FIG. 7 is a sectional view taken along a line 7-7 indicated in FIG. 6.

FIG. 8 is another enlarged view of a part of the first preferred embodiment of the present invention.

FIG. 9 is a sectional view taken along a line 9-9 indicated in FIG. 8.

FIG. 10 is a sectional view taken along a line 10-10 indicated in FIG. 8.

FIG. 11 is a sectional view taken along a line 11-11 indicated in FIG. 8.

FIG. 12 is another enlarged view of a part of the first preferred embodiment of the present invention.

FIG. 13 is a circuit block diagram of the lighting module in accordance with the first preferred embodiment of the present invention.

FIG. 14 is a sectional view taken along a line 14-14 indicated in FIG. 8.

FIG. 15 is similar to FIG. 14, illustrating that the button of the lighting device is located at the activation position.

FIG. 16 is a front perspective view of a second preferred embodiment of the present invention.

FIG. 17 is a front perspective view of a third preferred embodiment of the present invention.

FIG. 18 is a top view of the light device illustrated in FIG. 17.

FIG. 19 is a circuit block diagram of the lighting module in accordance with a third preferred embodiment of the present invention.

### DETAILED DESCRIPTION OF PREFERRED EMBODIMENTS

Structural features and desired effects of the present invention will become more fully understood by reference to three preferred embodiments given hereunder. However, it is to be understood that these embodiments are given by way of illustration only, thus are not limitative of the claim scope of the present invention.

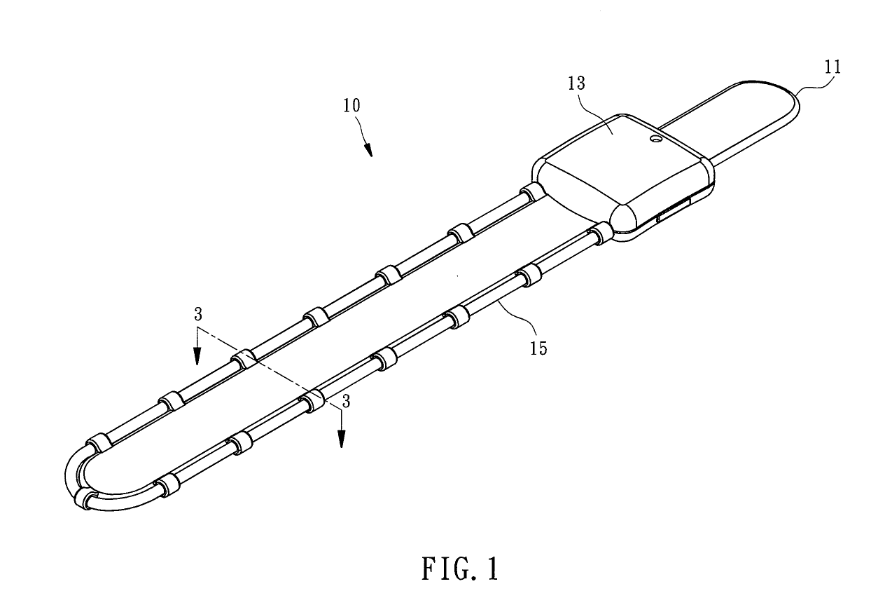

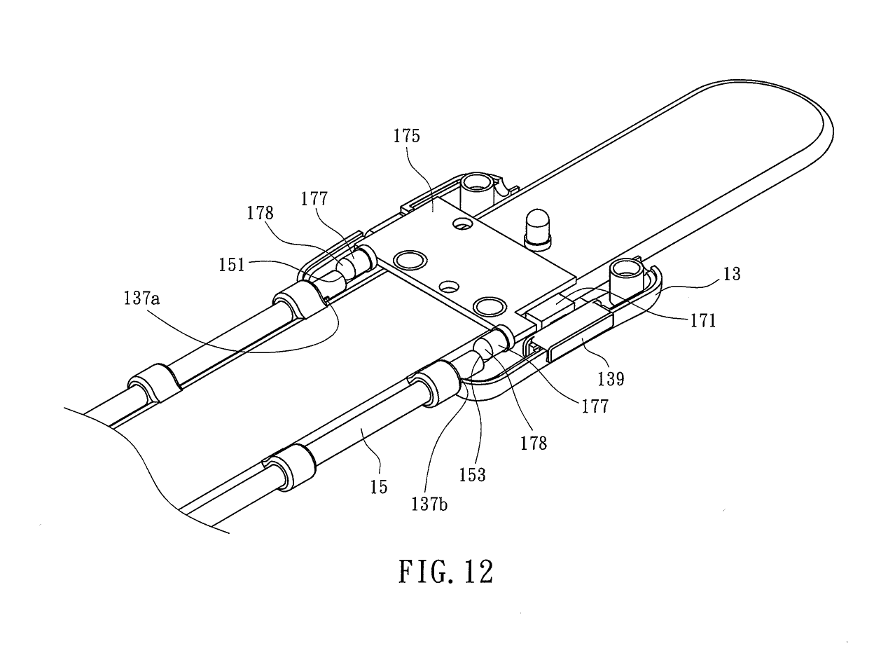

Referring to FIGS. 1-15, a lighting device 10 constructed according to a first preferred embodiment of the present invention is formed of a bistable spring 11, a housing 13, a first flexible light guide member 15, and a lighting module 17. The detailed descriptions and operations of these elements as well as their interrelations are recited in the respective paragraphs as follows.

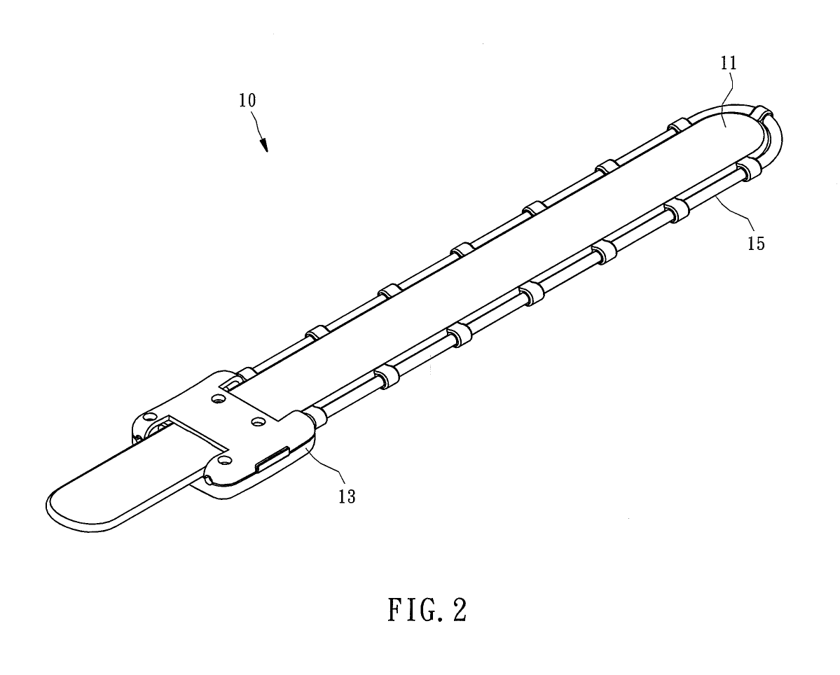

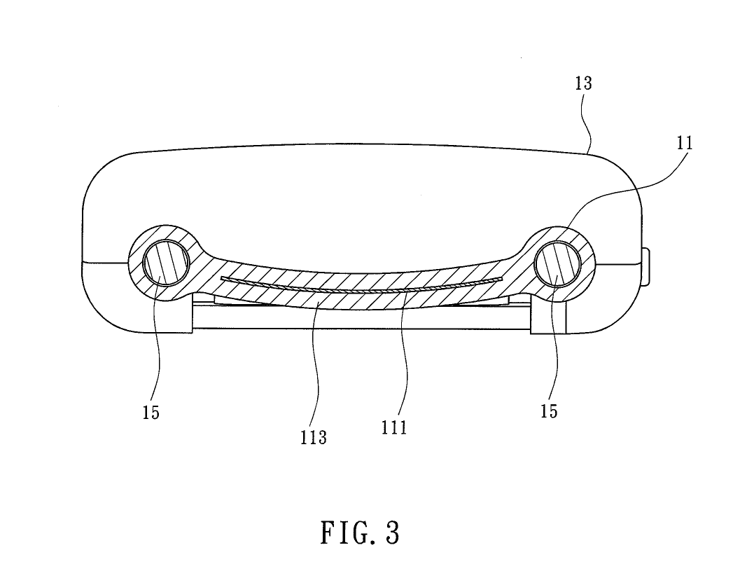

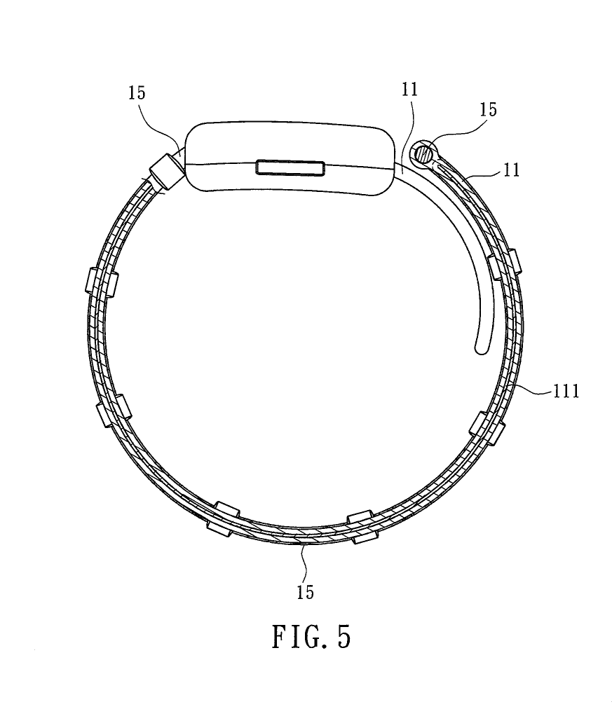

The bistable sprig 11 is changeable between an uncurled state and a curled state. FIGS. 1 and 2 illustrate the uncurled state of the bistable spring 11 and FIG. 5 illustrates the curled state of the bistable spring 11. As shown in FIG. 3, the bistable spring 11 includes a springy main body 111 and a covering layer 113. The covering layer 113 covers the springy main body 111. The springy main body 111 is an elongated straight metallic sheet, as shown in FIGS. 1 and 2, and is arc-shaped in the sectional view. The covering layer 113 is preferably made of plastic, silicon rubber, or textile.

The housing 13 is fixed to the bistable spring 11 and preferably made of plastic or metal.

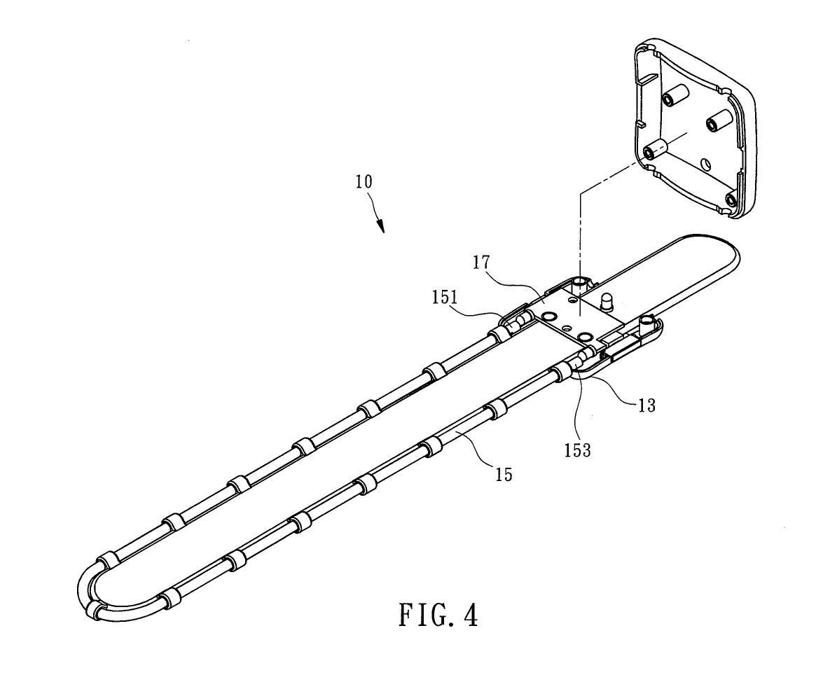

Referring to FIG. 4 again, the first flexible light guide member 15 is connected with the bistable spring 11 and includes two terminal portions 151 and 153, which are inserted into the housing 13. The first flexible light guide member 15 is bendable.

The lighting module 17 is mounted inside the housing 13 for emitting light toward the two terminal portions 151 and 153.

The first flexible light guide member 15 is transparent and not actively luminous, so it needs the lighting module 17 for illumination. According to the principle of total internal reflection of light, while the light enters the first flexible light guide member 15 through the two terminal portions 151 and 153, the light is internally reflected to make the first flexible light guide member 15 look luminous as a whole.

Referring to FIG. 5 again, when the bistable spring 11 is curled to become a circle, its diameter matches that of an object (not shown), which can be either of four human limbs, a buckle or strap of a backpack, an armrest of a baby cart, a wheelchair, or a bicycle rack. Specifically, the flexile light guide member 15 is bendable, so when the bistable spring 11 is curled, the first flexible light guide member 15 is curled altogether. If it is intended for the bistable spring 15 to be of the curled state from the uncurled state, a user only needs to flap the bistable spring 15 of the uncurled state to make the springy main body 111 become curled subject to its property and in this way, the bistable spring 11 can be conveniently and quickly mounted to the object. If it is intended to store the bistable spring 11 from the curled state back to the uncurled state, the user will only need to hold the two ends of the bistable spring to uncurl the main body 111.

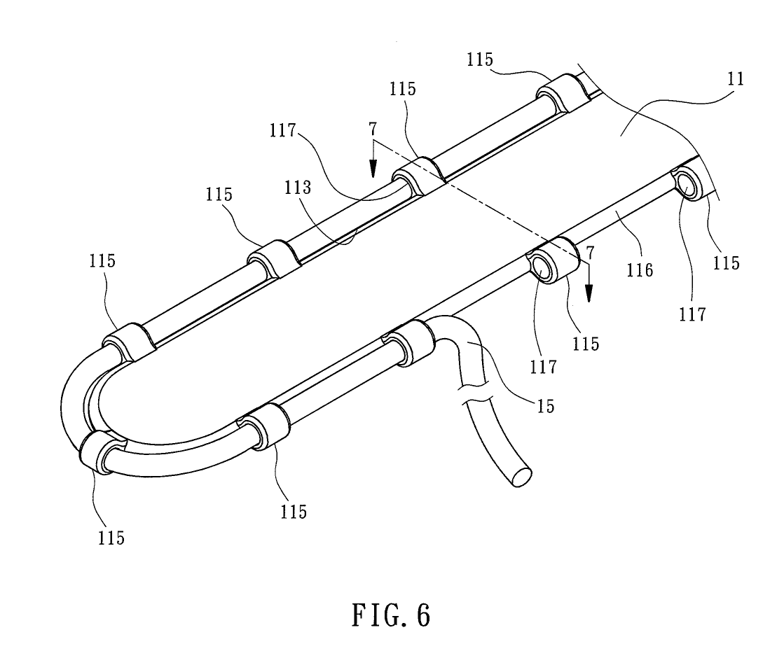

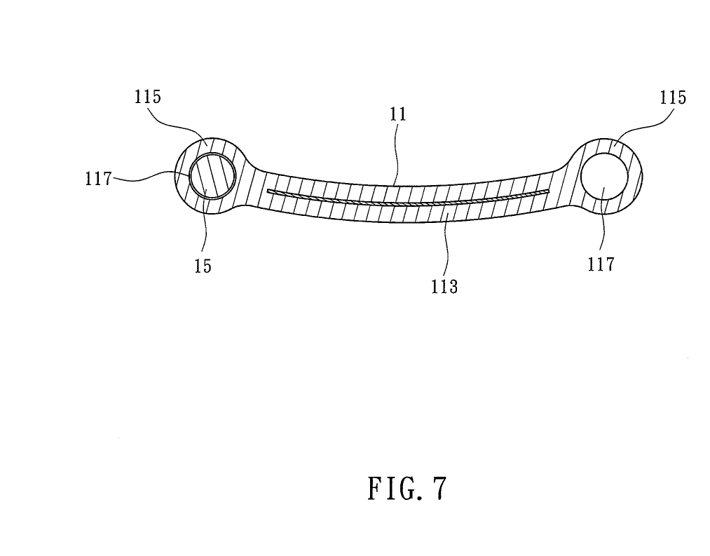

Referring to FIGS. 6 and 7, the bistable spring 11 further includes a plurality of linking units 115. The linking units 115 extend from the covering layer 113 and are arranged in an interval and connected with the first flexible light guide member 15. In this embodiment, each of the linking units 115 and the covering layer 113 is made of the same material. Each of the linking units 115 includes a through hole 117. The first flexible light guide member 15 passes through the through hole 117 of each linking unit 115 to be connected with the linking units 115. However, the connection between the linking units 115 and the first flexible light guide member 15 is not limited to the aforesaid way and the linking units 115 and the first flexible light guide member 15 can be buckled to each other. In addition, the linking units 115 are located at a peripheral edge 116 of the bistable spring 11, indicating that the first flexible light guide member 15 is arranged along the peripheral edge 116 of the bistable spring 11. However, the linking units 15 can be located elsewhere at the bistable spring 11 not limited to the peripheral edge 116 of the bistable spring 11.

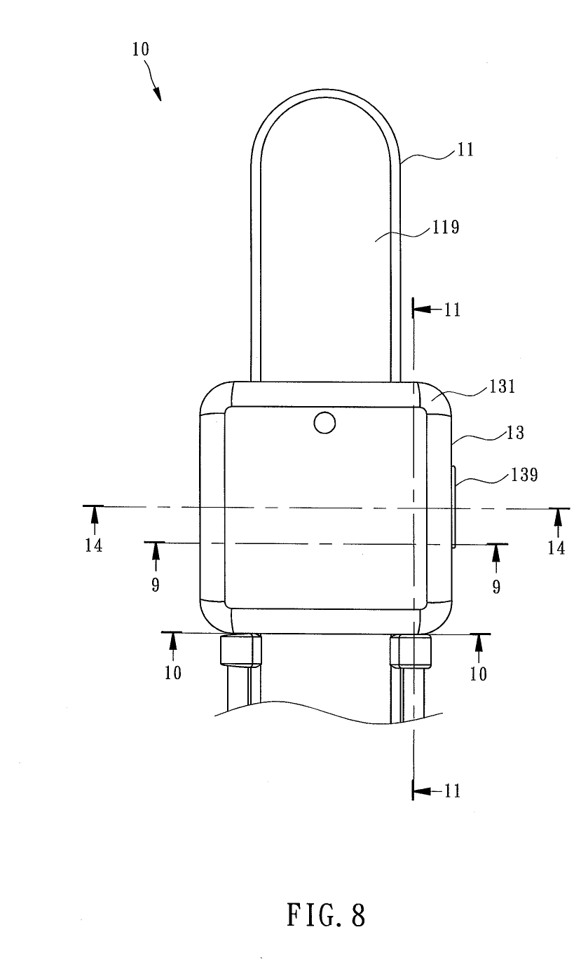

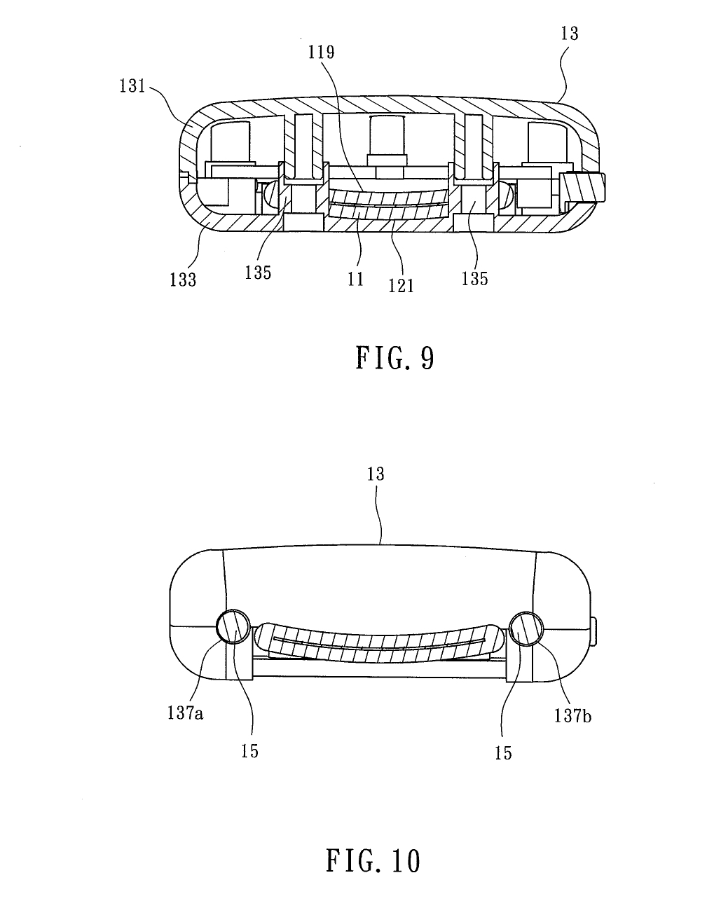

Referring to FIGS. 8 and 9, the bistable spring 11 includes a top arc-shaped surface 119 and a bottom arc-shaped surface 121. The housing 13 includes a first shell 131 and a second shell 133 mounted to the first shell 131. The first and second shells 131 and 133 can be connected by a screw bolt or a tenon. The second shell 133 includes two posts 135 inserted through the top and bottom arc-shaped surfaces 119 and 121 of the bistable spring 11 for fastening the housing 13 to the bistable spring 11. The bistable spring 11 is located between the first and second shells 131 and 133. In this way, the housing 13 is not movable relative to the bistable spring 11. However, the number of the posts 135 is not limited to two and can be only one.

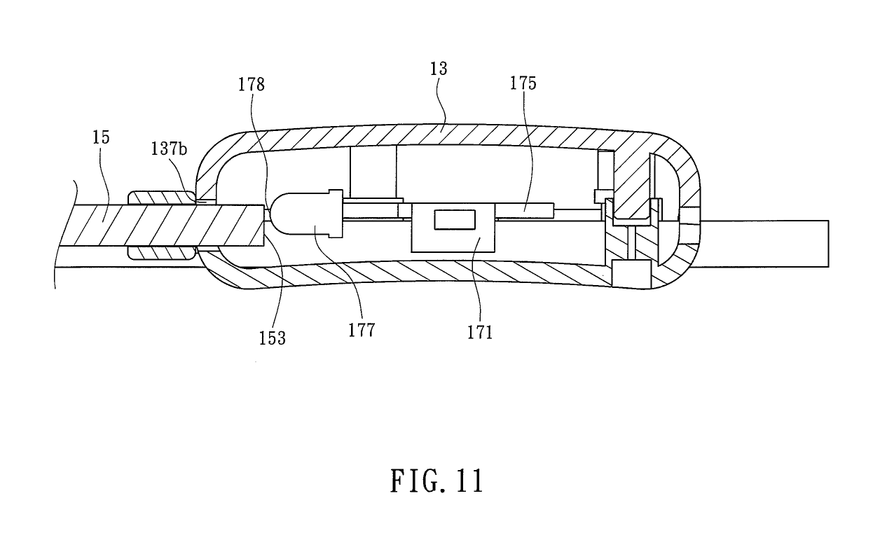

Referring to FIGS. 10 and 11, the housing 13 includes two first through hole 137a and 137b. The first flexible light guide member 15 is provided with two terminal portions 151 and 153 inserted through the two first gateways 137a and 137b, respectively for facilitating assembly of the first flexible light guide member 15 and the housing 13.

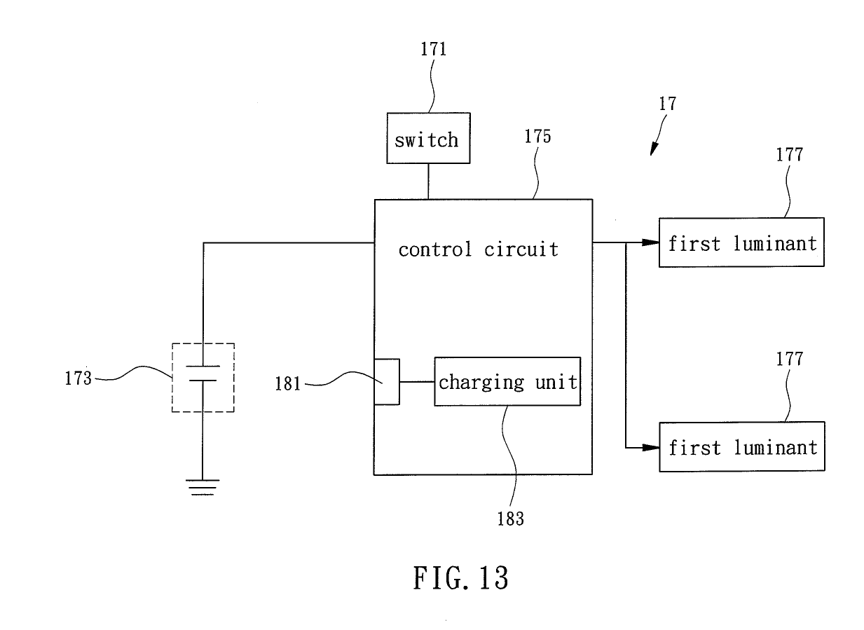

Referring to FIGS. 11 and 13, the lighting module 17 includes a switch 171, a battery 173, a control circuit 175, and two first luminants 177. The switch 171, the battery 173, and the two first luminants 177 are electrically connected with the control circuit 175. Each of the first luminants 177 includes a first light outgoing portion 178. The two first light outgoing portions 178 face the first gateways 137a and 137b, respectively, to enable the light generated by the two first luminants 177 to emit toward the two first gateways 137a and 137b through the two first light outgoing portions 178. Each of the first luminants 177 is a light-emitting diode (LED). In this way, the light of the two first luminants 177 can enter the two terminal portions 151 and 153 of the first flexible light guide member 15 successfully.

Referring to FIG. 13 again, as soon as the switch 171 triggers the control circuit 175, the battery 173 supplies electricity for the control circuit 175 to drive the two first luminants 177 to generate light. In this way, the light of the first luminants 177 enter the first flexible light guide member 15 through the two terminal portions 151 and 152. It is worth mentioning that the control circuit 175 can selectively drives the two first luminants 177 to generate flashes of different frequencies or continuous light.

As soon as the switch 171 triggers the control circuit 175 again, the battery 173 stops supplying any electricity for the control circuit 175. In other words, the control circuit 175 is switched off and the first luminants 177 no longer generate any light or flash.

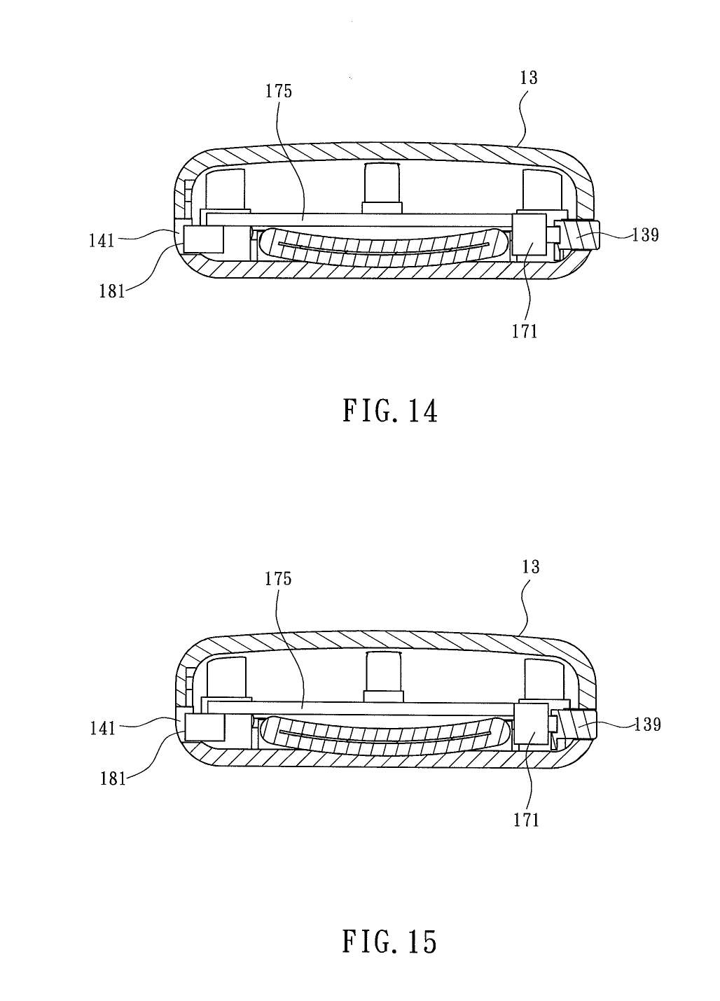

Referring to FIGS. 14 and 15, the housing 13 includes a button 139 for controlling the switch 171. The button 139 is movable to a trigger position (FIG. 15) from an original position (FIG. 14). When the button 139 is pushed by an external force, the button 139 is located at the trigger position to control and make the switch 171 trigger the control circuit 175. When the external force vanishes, the button 139 returns to the original position and meanwhile, the switch 171 does not trigger the control circuit 175. However, the switch 171 can be controlled by other means not limited to the button 139.

Referring to FIGS. 13-15, the housing 13 includes an insertion hole 141. The control module 175 further includes a socket 181 and a charging unit 183. The socket 181 is electrically connected with the charging unit 183 and located inside the insertion hole 141 of the housing 13. The charging unit 183 is to charge the battery 173. For example, if the socket 181 is a conventional universal serial bus (USB) socket and the battery 173 is a lithium battery, a transmission cable (not shown) having a USB plug can be inserted into the USB socket and an external power source (not shown) and thereby the charging unit 183 can charge the lithium battery. However, the socket 181 is not limited to the aforesaid USB socket and can be an IEEE 1394 socket. In addition, the battery 173 can be a nickel-metal hydride battery or a secondary battery, not limited to the lithium battery. Since the battery 173 can be a secondary battery, which is rechargeable and dischargeable, the lighting device 10 of the present invention is reusable and does not need to replace any button cell battery or any dry cell battery to be environmentally friendly.

If the battery 173 is not a secondary battery, the insertion hole 141 of the housing 13, the socket 181, and the charging unit 183 will be no longer necessary.

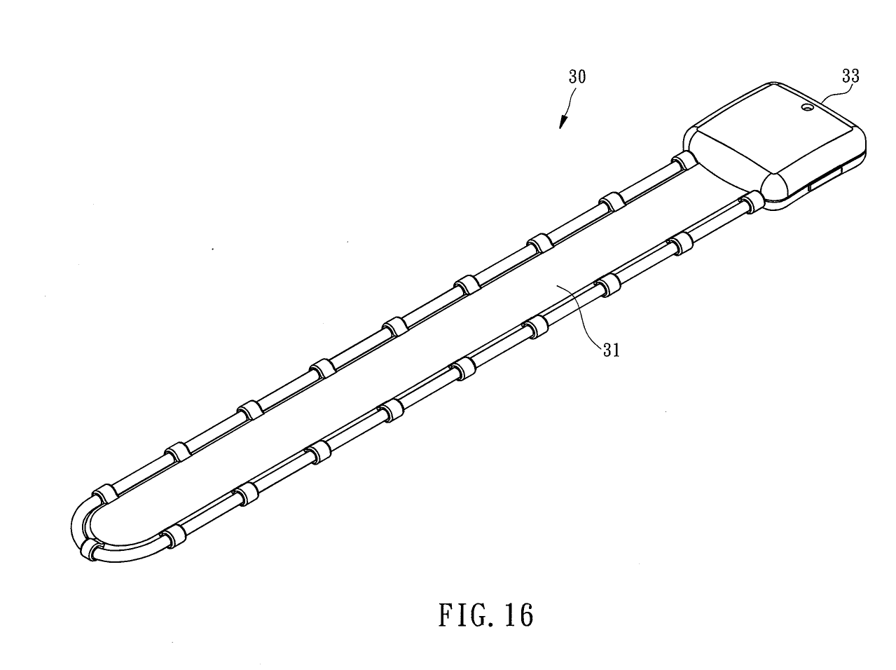

Referring to FIG. 16, in a second preferred embodiment of the present invention, the composition, purpose, and application of the lighting device are identical to those of the first preferred embodiment, so detailed recitation is omitted. The difference between the two preferred embodiments lies in that the housing 33 of the lighting device of the second preferred embodiment is located at a distal end of the bistable spring 31, so the location of the housing 33 is not limited to that of the housing 13.

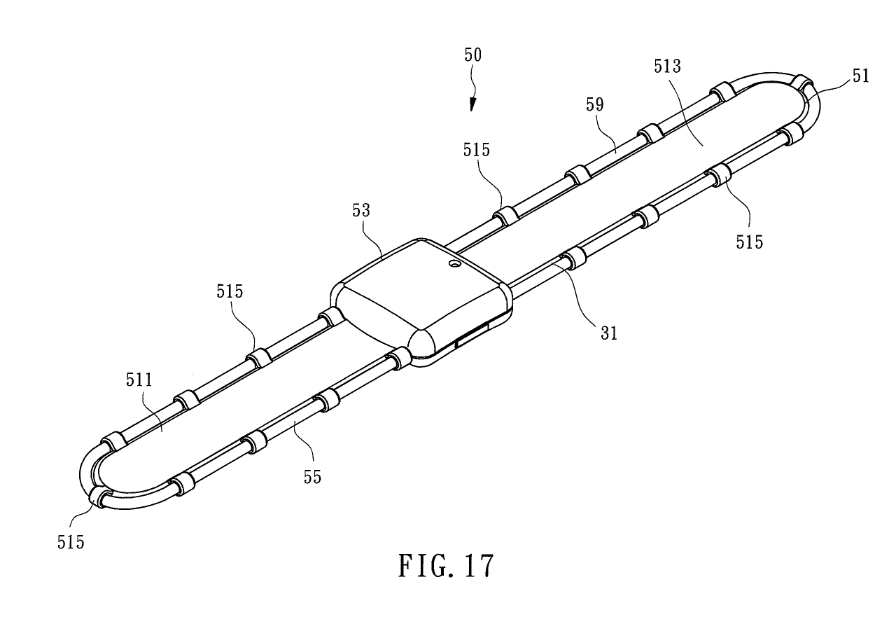

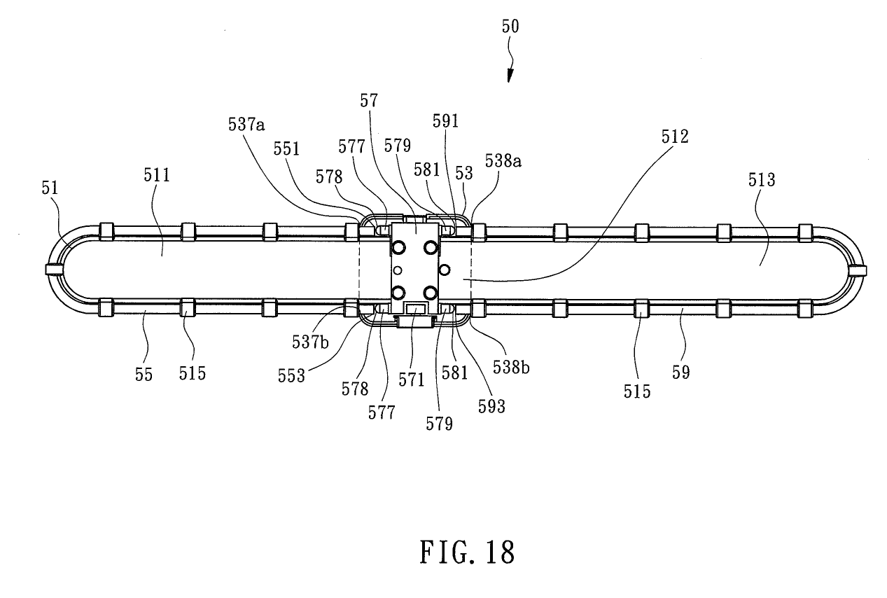

Referring to FIGS. 17 and 18, the former shows the complete perspective view of the light device 50 and the latter shows a top view of the lighting device 50 without the first shell of the housing 53. In a third preferred embodiment of the present invention, the composition, purpose, and application of the lighting device 50 are identical to those of the first preferred embodiment, so detail recitation is omitted. The difference between the third and first preferred embodiments lies in that the lighting device 50 of the third preferred embodiment further includes a second flexible light guide member 59. The second flexible light guide member 59 is connected with the bistable spring 51 and provided with two terminal portions 591 and 593. The second flexible light guide member 59 and the bistable spring 51 are connected via the linking units 515. The arrangement, structure, and purpose of the linking unit 515 of the third preferred embodiment are identical to those of the linking unit 115 of the first preferred embodiment, so detailed recitation is omitted. The two terminal portions 591 and 593 are inserted into the housing 53. The bistable spring 51 includes a front part 511, a middle part 512, and a rear part 513 as shown in FIG. 18, in which the front part 511, the middle part 512, and the rear part 513 are though sectionalized by two broken lines, but the two broken lines are nothing actually. The first flexible light guide member 55 is located at the front part 511 of the bistable spring 51. The housing 53 is located at the middle part 512 of the bistable spring 51. The second flexible light guide member 59 is located at the rear part 513 of the bistable spring 51. The lighting module 57 can generate and emit the light toward the two terminal portions 591 and 593 of the second flexible light guide member 59 in addition to the first flexible light guide member 55.

In addition to the two first gateways 537a and 537b, the housing 53 further includes two second gateways 538a and 538b. The two terminal portions 591 and 593 are inserted through the two second gateways 538a and 538b.

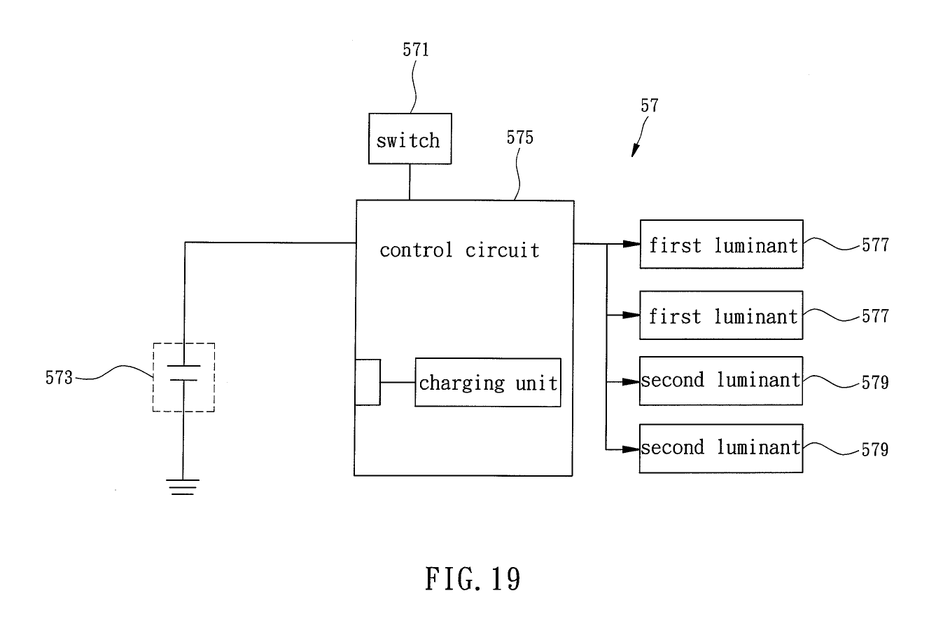

Referring to FIG. 19 in view of FIG. 18 again, in addition to the first luminants 577, the lighting module 57 further includes two second luminants 579 connected with the control circuit 575. Each of the two second luminants 579 includes a second light outgoing portion 581. The two second light outgoing portions 581 face the two second gateways 538a and 538b, respectively. As soon as the switch triggers the control circuit 575, the battery 573 supplies electricity for the control circuit 575 to drive the two first luminants 577 and the two second luminants 579 to generate and emit light through the two first light outgoing portions 578 and the two second light outgoing portions 581. As soon as the switch 571 triggers the control circuit 575 again, the battery 573 stops supplying any electricity for the control circuit 575. The connection, operation, and purpose of the switch 571, the control circuit 575, and the battery 573 of the third preferred embodiment are identical to those of the first preferred embodiment, so more recitation is omitted. In this way, the two terminal portions 551 and 553 of the first flexible light guide member 55 and the two terminal portions 591 and 593 of the second flexible light guide member 59 receive the visible light and the light are reflected inside the first and second flexible light guide members 55 and 59 to make the first and second flexible light guide members 55 and 59 reveal the light as a whole. It is worth mentioning that the lighting module 57 simultaneously drives the first and second luminants 577 and 579 to generate the light.

The structures, operations, and purposes of the button and insertion hole of the housing and the socket and charging unit of the control circuit of the third preferred embodiment are identical to those of the first preferred embodiment, so further recitation is omitted.

In conclusion, the lighting device of the present invention can improve the deficiency of the prior art. In addition, each light guide member needs to work with two luminants only, so the number of the luminant installed and the power consumption of the battery can be reduced.

What is claimed is:

1. A lighting device comprising:
a bistable spring having an uncurled state and a curled state and having a springy main body and a covering layer, the covering layer covering the springy main body;
a housing fixed to the bistable spring;
a first flexible light guide member connected with the bistable spring and having two terminal portions, the two terminal portions being inserted into the housing; and
a lighting module mounted inside the housing for generating light toward the two terminal portions.

2. The lighting device as defined in claim 1, wherein the bistable spring further comprises a plurality of linking units extending from the covering layer and arranged in an interval and connected with the first flexible light guide member.

3. The lighting device as defined in claim 2, wherein the linking units are located at a peripheral edge of the bistable spring, each of the linking units having a through hole; the first flexible light guide member passing through the through hole of each linking unit.

4. The lighting device as defined in claim 1, wherein the housing comprises a first shell and a second shell mounted to the first shell, the second shell having at least one post passing through the bistable spring, the bistable spring being located between the first and second shells.

5. The lighting device as defined in claim 1, wherein the housing comprises two first gateways and the two terminal portions of the first flexible light guide member are inserted through the two first gateways.

6. The lighting device as defined in claim 5, wherein the lighting module comprises a switch, a battery, a control circuit, and two first luminants, the switch, the battery, and the two first luminants being connected with the control circuit, each of the first luminants having a first light outgoing portion, the two first light outgoing portions facing the two first gateways, respectively; as soon as the switch triggers the control circuit, the battery supplies electricity for the control circuit to drive the two first luminants to generate and emit light through the two first light outgoing portions.

7. The lighting device as defined in claim 6, wherein as soon as the switch triggers the control circuit again, the battery stops supplying any electricity for the control circuit.

8. The lighting device as defined in claim 7, wherein the housing comprises a button for controlling the switch.

9. The lighting device as defined in claim 7, wherein the housing comprises an insertion hole and the control module comprises a socket and a charging unit, the socket being located inside the insertion hole of the housing and connected with the charging unit, the charging unit being adapted for charging the battery.

10. The lighting device as defined in claim 1 further comprising a second flexible light guide member, wherein the second flexible light guide member is connected with the bistable spring and has two terminal portions inserted into the housing, the bistable spring having a front part, a middle part, and a rear part, the first flexible light guide member being located at the front part of the bistable spring, the housing being located at the middle part of the bistable spring, the second flexible light guide member being located at the rear part of the bistable spring; the lighting module being adapted for generating the light for the two terminal portions of the second flexible light guide member.

11. The lighting device as defined in claim 10, wherein the bistable spring further comprises a plurality of linking units extending from the covering layer, the linking units being arranged in an interval and connected with the first and second flexible light guide members.

12. The lighting device as defined in claim 11, wherein the liking units are located at a peripheral edge of the bistable spring, each of the linking units having a through hole; the first and second flexible light guide members pass through the through hole of each first linking unit.

13. The lighting device as defined in claim 10, wherein the housing comprises two first gateways and two second gateways; the two terminal portions of the first flexible light guide member are inserted through the two first gateways, respectively;
the two terminal portions of the second flexible light guide member are inserted through the two second gateways, respectively.

14. The lighting device as defined in claim 13, wherein the lighting module comprises a switch, a battery, a control circuit, two first luminants, and two second luminants, the switch, the battery, and the first and second luminants being connected with the control circuit, each of the first luminants having a first light outgoing portion, the two first light outgoing portions facing the two first gateways, respectively, each of the second luminants having a second light outgoing portion, the two second light outgoing portions facing the two second gateways, respectively; as soon as the switch triggers the control circuit, the battery supplies electricity for the control circuit to drive the first and second luminants to generate and emit light through the first and second light outgoing portions.

15. The lighting device as defined in claim 14, wherein as soon as the switch triggers the control circuit again, the battery stops supplying any electricity for the control circuit.

16. The lighting device as defined in claim 15, wherein the housing comprises a button for controlling the switch.

17. The lighting device as defined in claim 15, wherein the housing comprises an insertion hole and the control module comprises a socket and a charging unit, the socket being located inside the insertion hole of the housing and connected with the charging unit, the charging unit being adapted for charging the battery.
